(19) United States
(12) Patent Application Publication
(10) Pub. No.: US 2015/0138657 A1
(43) Pub. Date: May 21, 2015

(54) ANTENNA APPARATUS

(71) Applicant: Electronics and Telecommunications Research Institute, Daejeon (KR)

(72) Inventors: Woo Jin BYUN, Daejeon (KR); Yong Heui CHO, Daejeon (KR); Kwang Seon KIM, Daejeon (KR); Bong Su KIM, Daejeon (KR); Min Soo KANG, Daejeon (KR); Jong Soo LIM, Daejeon (KR)

(21) Appl. No.: 14/549,299

(22) Filed: Nov. 20, 2014

(30) Foreign Application Priority Data
Nov. 21, 2013 (KR) 10-2013-0141890
Nov. 18, 2014 (KR) 10-2014-0160566

(51) Int. Cl. G02B 5/08

(52) U.S. Cl. CPC G02B 5/08
USPC 359/850

(57) ABSTRACT

The disclosure provides an antenna apparatus. Disclosed is an antenna apparatus comprising a power feeding unit receiving an electromagnetic wave from a transmitter and providing the received electromagnetic wave to the antenna apparatus, a sub reflector generating an OAM (Orbital Angular Momentum) mode electromagnetic wave, and a main reflector reflecting the generated OAM mode electromagnetic wave to a far field region.

This application claims the benefit of priority of Korean Patent Application No. 10-2013-0141890 filed on Nov. 21, 2013, and Korean Patent Application No. 10-2014-0160566 filed on Nov. 18, 2014, which are incorporated by reference as if fully set forth.

### BACKGROUND OF THE INVENTION

1. Field of the invention

The present invention relates to wireless communications, and more specifically, to a reflector antenna.

2. Related Art

Most of frequency bands currently being used for wireless communication are actively being used densely without white bands. To expand the current popular multimedia data services, the use efficiency of the existing frequency bands should be significantly increased. For such purposes, a primary method uses electromagnetic wave polarization or multi-antenna characteristics. Use of such scheme enables utilization of a new channel created by the polarization or multiple antennas even when the same frequency is put in use, thus increasing frequency use efficiency. However, this scheme also has a limit in increasing data rate. Accordingly, there is ongoing research for a new communication scheme adopting OAM (Orbital Angular Momentum) mode primarily in the optical communication fields. The OAM mode communication is a communication scheme that may distinguish communication signals from each other using mathematical orthogonality of OAM mode even though the frequency, polarization, and multi-antenna array characteristics remain the same.

In the optical communication fields, the OAM mode communication scheme has different characteristics from those of non-visible electromagnetic waves being used for wireless communications. The visible electromagnetic waves used for optical communication have very short wavelengths, and lenses, holograms, or beam splitters of better quality may be thus created. The non-visible electromagnetic waves have relatively long wavelengths, and thus, antennas for generating OAM mode as commercially available are difficult to develop.

Accordingly, a need exists for a technology for providing an antenna that may easily generate OAM mode.

### SUMMARY OF THE INVENTION

The present invention provides an antenna apparatus for easily developing an antenna for OAM mode.

The present invention provides an antenna apparatus that may generate OAM mode by transforming a sub reflector.

The present invention provides an antenna apparatus that may generate OAM mode by utilizing the design of a conventional main reflector and power feeding unit.

According to an aspect of the present invention, an antenna apparatus is provided. The antenna apparatus may comprise a power feeding unit receiving an electromagnetic wave from a transmitter and providing the received electromagnetic wave to the antenna apparatus, a sub reflector generating an OAM (Orbital Angular Momentum) mode electromagnetic wave, and a main reflector reflecting the generated OAM mode electromagnetic wave to a far field region.

According to another aspect of the present invention, the sub reflector may have a step between an uppermost portion of a dish and a lowermost portion of the dish.

According to still another aspect of the present invention, the sub reflector may be formed on the main reflector to be spaced apart from the main reflector.

According to yet still another aspect of the present invention, the sub reflector may be supported by the power feeding unit.

According to yet still another aspect of the present invention, the sub reflector may be a Cassegrain-type sub reflector.

According to yet still another aspect of the present invention, the sub reflector may be a Gregorian-type sub reflector.

According to yet still another aspect of the present invention, the sub reflector may be an ADE (Axially Displaced Ellipse)-type sub reflector.

According to yet still another aspect of the present invention, the sub reflector may have a plurality of steps.

According to another aspect of the present invention, an antenna apparatus is provided. The antenna apparatus may comprise a power feeding unit receiving an electromagnetic wave from a transmitter and providing the received electromagnetic wave to the antenna apparatus, a sub reflector having a step to generate an OAM (Orbital Angular Momentum) mode electromagnetic wave, and a main reflector reflecting the generated OAM mode electromagnetic wave to a far field region.

According to still another aspect of the present invention, the sub reflector may have a step between an uppermost portion of a dish and a lowermost portion of the dish.

According to yet still another aspect of the present invention, the sub reflector may be formed on the main reflector to be spaced apart from the main reflector.

According to yet still another aspect of the present invention, the sub reflector may be supported by the power feeding unit.

According to yet still another aspect of the present invention, the sub reflector may be a Cassegrain-type sub reflector.

According to yet still another aspect of the present invention, the sub reflector may be a Gregorian-type sub reflector.

According to yet still another aspect of the present invention, the sub reflector may be an ADE (Axially Displaced Ellipse)-type sub reflector.

the sub reflector may have a plurality of steps.

According to the present invention, OAM mode may be generated by utilizing the design of the conventional main reflector and power feeding unit while transforming only the sub reflector, thus leading to savings in costs for developing and manufacturing antennas.

Further, various present techniques for designing main reflectors and power feeding units may be actively utilized for OAM mode generating reflectors for non-visible electromagnetic waves.

### BRIEF DESCRIPTION OF THE DRAWINGS

FIG. 1 illustrates the structure of an OAM mode generating resource allocation;

FIG. 2 illustrates the structure of an OAM mode generating resource allocation according to an embodiment of the present invention;

FIG. 3 is a graph showing the result of calculation of a far-field region electromagnetic wave of the antenna of FIG. 2, according to an embodiment of the present invention; and

FIG. 4 illustrates the structure of an OAM mode generating resource allocation according to another embodiment of the present invention.

### DESCRIPTION OF EXEMPLARY EMBODIMENTS

Hereinafter, embodiments of the present invention are described in detail to be easily practiced by one of ordinary skill in the art to which the present invention pertains. However, the present invention may be implemented in other various ways and is not limited to the embodiments set forth herein. The part of the drawings which are not related to the present invention is skipped from description thereof for better understanding. The same or similar denotations are used to refer to the same or similar elements throughout the specification and the drawings.

As used herein, when an element “comprises” another element, the element may further include the other element unless stated otherwise. Further, as used herein, the term “unit” refers to a unit that processes at least one function or operation and may be implemented in hardware, software, or a combination thereof.

Embodiments of the present invention are described with reference to the accompanying drawings.

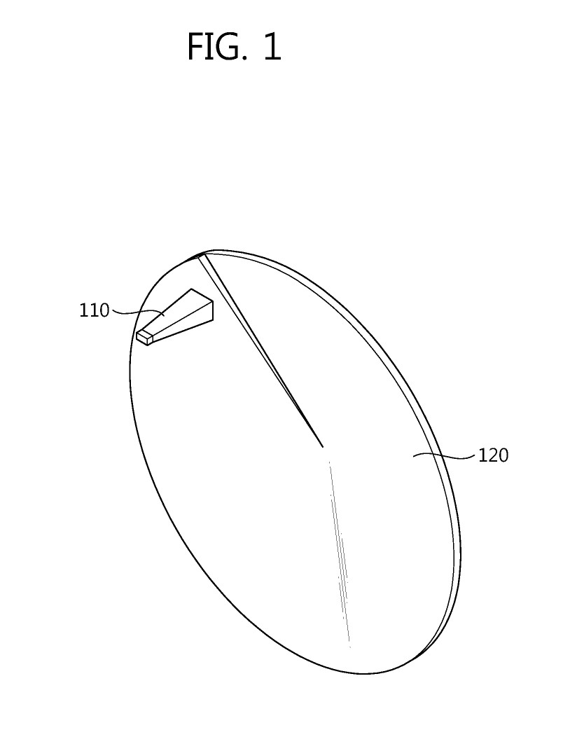

FIG. 1 illustrates the structure of an OAM mode generating resource allocation. A typical OAM mode generating reflector antenna includes a power feeding unit 110 and a main reflector 120. An electromagnetic wave may be radiated and generated through the power feeding unit 110 to the main reflector 120. The main reflector 120 may be formed by geometrically transforming a disc-shaped antenna so that a reflected electromagnetic wave has the same phase as an OAM mode phase. However, transforming the main reflector 120 for generating OAM mode is inefficient in the point of view that a large area of the reflector should be processed.

To address the above issue, the present invention proposes a method of utilizing a sub reflector for generating OAM mode, wherein the sub reflector is relatively small in area as compared with the main reflector 120 and may be thus easily transformed. The physical structure of the sub reflector may be determined based on Equation 1 below:

[Equation 1]

z_{OAM}(x, y)=z_{org}(x, y)+φ(x, y; m)

In Equation 1, the z-axis direction denotes a direction of the power feeding unit 110 with respect to the main reflector 120 as shown in FIG. 1. z_{OAM}(x, y) refers to a transformed geometrical structure of the sub reflector to generate OAM mode. z_{org}(x, y) refers to a geometrical structure of a typical sub reflector with respect to x and y, and φ(x, y; m) refers to a changed z-axis distance for phase variation for generating an mth OAM mode. Equation 1 above may apply to all the conventional sub reflectors. For example, the equation may be applicable to Cassegrain-type sub reflectors using a hyperboloid, Gregorian-type sub reflectors using an elliptical surface, and ADE (Axially Displaced Ellipse)-type sub reflectors using ellipses spaced apart from each other in an axial direction. In other words, when the physical structure of the sub reflector is determined according to Equation 1, a lower-order or higher-order OAM mode may be easily created.

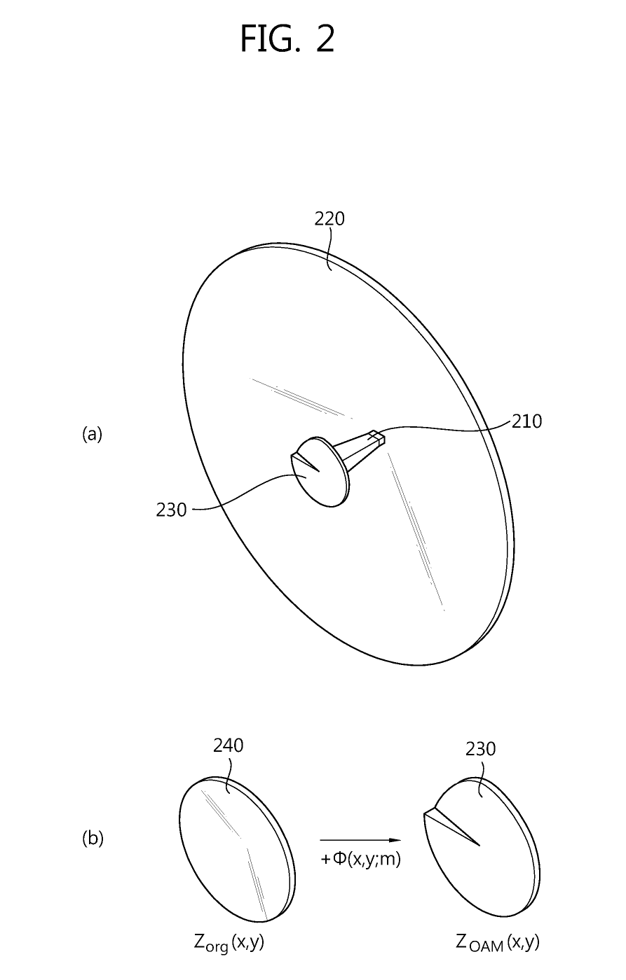

FIG. 2 illustrates the structure of an OAM mode generating resource allocation according to an embodiment of the present invention. FIG. 2 shows a parabolic reflector antenna for generating OAM mode, wherein the reflector antenna has a Cassegrain-type sub reflector transformed based on Equation 1, as an example. Here, assume m=1.

Referring to FIG. 2, according to an embodiment of the present invention, an OAM mode generating reflector antenna includes a power feeding unit 210, a main reflector 220, and a sub reflector 230. The sub reflector 230 is formed on the main reflector 220 to be spaced apart from the main reflector 220, and the sub reflector 230 may be supported by the power feeding unit 210. In the instant embodiment, the sub reflector 230 may be formed by transforming a Cassegrain-type sub reflector 240. The Cassegrain-type sub reflector 240 is shaped as a hyperbola, and in the present embodiment, z_{org}(x, y) in Equation 1 may be thus set to represent a hyperboloid shape. The main reflector 220 reflects an OAM mode electromagnetic wave generated from the sub reflector 230 to a far field region. The main reflector 220 may use a typical form of main reflector. Examples of the main reflector 220 may include a parabolic reflector and a reflectarray. In contrast, the sub reflector 230, unlike the typical Cassegrain-type sub reflector 240, is transformed in a z-axis direction to have a step between an uppermost portion of a dish and a lowermost portion of the dish to thus generate an OAM mode electromagnetic wave. As used herein, the term “dish” refers to a surface of a reflector such as the main reflector or sub reflector to reflect an electromagnetic wave to the outside. The sub reflector 230 may be supported by the power feeding unit 210 to be formed on the main reflector 220 to be spaced apart from the main reflector 220. The power feeding unit 210 receives an electromagnetic wave from a transmitter and provides the received electromagnetic wave to the antenna apparatus. In this embodiment, the power feeding unit 210 may have a typical form of power feeding unit.

According to this embodiment, the antenna apparatus for generating an OAM mode electromagnetic wave utilizes, as is, the design of a conventional main reflector and power feeding unit, only with the sub reflector transformed, to generate an OAM mode electromagnetic wave. Accordingly, high convenience may be offered to the antenna designer. Further, various types of main reflectors and power feeding units may be adopted depending on applications, thus allowing for designing diverse types of OAM mode generating antennas.

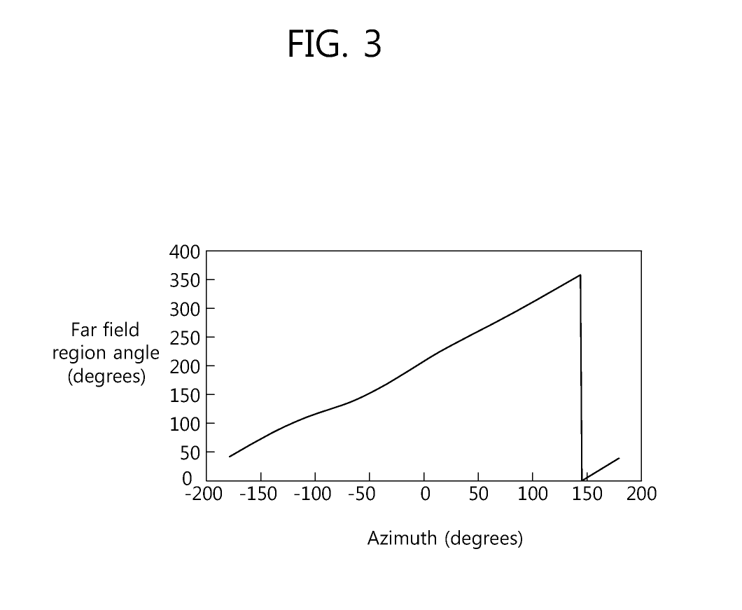

FIG. 3 is a graph showing the result of calculation of a far-field region electromagnetic wave of the OAM mode generating reflector antenna of FIG. 2, according to an embodiment of the present invention. If an OAM mode is generated, the phase of a far field region electromagnetic wave in an azimuth (φ) direction is linearly varied. Since in FIG. 2 an m=1 OAM mode is generated, as φ rotates a full turn, the phase of the far field region electromagnetic wave is varied by 360 degrees as well.

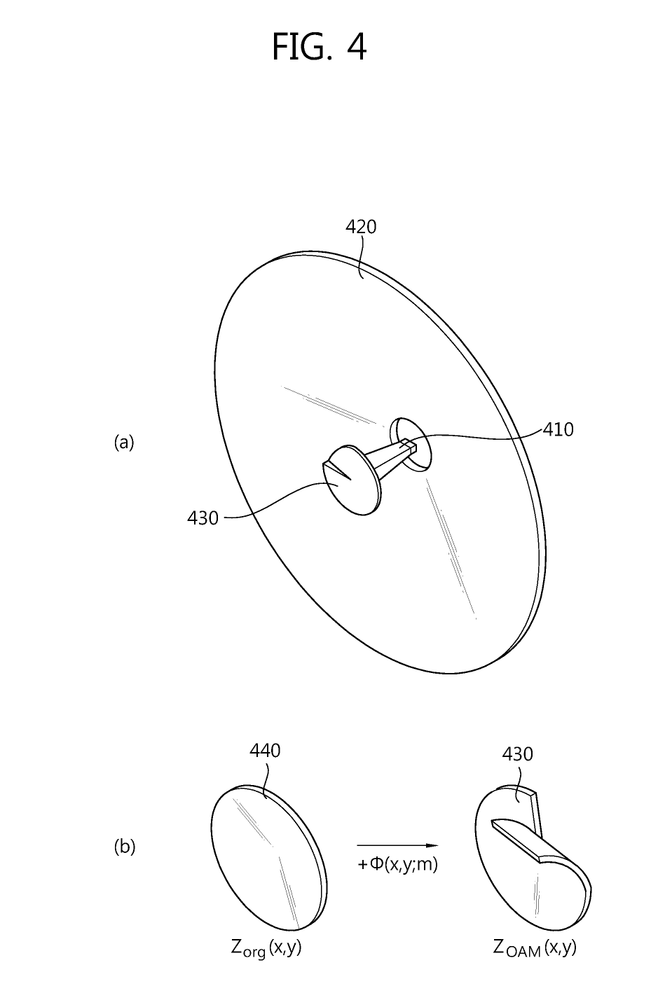

FIG. 4 illustrates the structure of an OAM mode generating resource allocation according to another embodiment of the present invention. FIG. 4 shows a parabolic reflector antenna for generating OAM mode, wherein the reflector antenna has an ADE-type sub reflector transformed based on Equation 1, as an example. Here, assume m=1.

Referring to FIG. 4, according to an embodiment of the present invention, an OAM mode generating reflector antenna includes a power feeding unit 410, a main reflector 420, and a sub reflector 430. The sub reflector 430 is formed on the main reflector 420 to be spaced apart from the main reflector 220, and the sub reflector 230 may be supported by the power feeding unit 410. In the instant embodiment, the sub reflector 430 may be formed by transforming an ADE-type sub reflector 440. In the present embodiment, z_{org}(x, y) in Equation 1 may be thus set to represent an ADE-type sub reflector shape. The main reflector 420 reflects an OAM mode electromagnetic wave generated from the sub reflector 430 to a far field region. The main reflector 420 may use a typical form of main reflector. Examples of the main reflector 420 may include a parabolic reflector and a reflect array. In contrast, the sub reflector 430, unlike the typical ADE-type sub reflector 440, is transformed in a z-axis direction to have a step between its uppermost portion and lowermost portion to thus generate an OAM mode electromagnetic wave. The sub reflector 430 may be supported by the power feeding unit 410 to be formed on the main reflector 420 to be spaced apart from the main reflector 220. The power feeding unit 410 receives an electromagnetic wave from a transmitter and provides the received electromagnetic wave to the antenna apparatus. In this embodiment, the power feeding unit 410 may have a typical form of power feeding unit.

According to this embodiment, the antenna apparatus for generating an OAM mode electromagnetic wave utilizes, as is, the design of a conventional main reflector and power feeding unit, only with the sub reflector transformed, to generate an OAM mode electromagnetic wave. Accordingly, high convenience may be offered to the antenna designer. Further, various types of main reflectors and power feeding units may be adopted depending on applications, thus allowing for designing diverse types of OAM mode generating antennas.

Although the present invention has been described in connection with embodiments thereof, it should be appreciated that various changes may be made thereto without departing from the essential characteristics of the present invention. Accordingly, it should be understood that the embodiments set forth herein are provided for descriptive purposes, rather than as limiting the present invention, and the spirit of the present invention is not limited thereby and thereto. The scope of the present invention should be interpreted by the following claims, and it should be noted that all equivalents to the present invention also belong to the scope of the present invention.

What is claimed is:

1. An antenna apparatus, comprising:
a power feeding unit receiving an electromagnetic wave from a transmitter and providing the received electromagnetic wave to the antenna apparatus;
a sub reflector generating an OAM (Orbital Angular Momentum) mode electromagnetic wave; and
a main reflector reflecting the generated OAM mode electromagnetic wave to a far field region.

2. The antenna apparatus of claim 1, wherein the sub reflector has a step between an uppermost portion of a dish and a lowermost portion of the dish.

3. The antenna apparatus of claim 1, wherein the sub reflector is formed on the main reflector to be spaced apart from the main reflector.

4. The antenna apparatus of claim 1, wherein the sub reflector is supported by the power feeding unit.

5. The antenna apparatus of claim 1, wherein the sub reflector is a Cassegrain-type sub reflector.

6. The antenna apparatus of claim 1, wherein the sub reflector is a Gregorian-type sub reflector.

7. The antenna apparatus of claim 1, wherein the sub reflector is an ADE (Axially Displaced Ellipse)-type sub reflector.

8. The antenna apparatus of claim 2, wherein the sub reflector has a plurality of steps.

9. An antenna apparatus, comprising:
a power feeding unit receiving an electromagnetic wave from a transmitter and providing the received electromagnetic wave to the antenna apparatus;
a sub reflector having a step to generate an OAM (Orbital Angular Momentum) mode electromagnetic wave; and
a main reflector reflecting the generated OAM mode electromagnetic wave to a far field region.

10. The antenna apparatus of claim 9, wherein the sub reflector has a step between an uppermost portion of a dish and a lowermost portion of the dish.

11. The antenna apparatus of claim 9, wherein the sub reflector is formed on the main reflector to be spaced apart from the main reflector.

12. The antenna apparatus of claim 9, wherein the sub reflector is supported by the power feeding unit.

13. The antenna apparatus of claim 9, wherein the sub reflector is a Cassegrain-type sub reflector.

14. The antenna apparatus of claim 9, wherein the sub reflector is a Gregorian-type sub reflector.

15. The antenna apparatus of claim 9, wherein the sub reflector is an ADE (Axially Displaced Ellipse)-type sub reflector.

16. The antenna apparatus of claim 9, wherein the sub reflector has a plurality of steps.
